(19) United States
(12) Patent Application Publication
(10) Pub. No.: US 2013/0084537 A1
(43) Pub. Date: Apr. 4, 2013

(54) APPARATUS AND METHOD FOR USE IN CREATING DENTAL PROSTHETICS

(71) Applicant: David CHO, Citrus Heights, CA (US)

(72) Inventor: David CHO, Citrus Heights, CA (US)

(21) Appl. No.: 13/252,013

(22) Filed: Oct. 3, 2011

(51) Int. Cl. A61C 19/045

(52) U.S. Cl. 433/29

(57) ABSTRACT

An apparatus and method for creating dental prosthetics with greater accuracy and consistency is provided. The apparatus includes a base, an ear mount portion for making contact with a patient's head such that the patient's temporomandibular joints are maintained in a fixed level position relative to the base, a chin mount portion for making contact with the patient's chin and nose bridge such that the chin mount portion maintains the patient's head in a perpendicular orientation relative to the base, a bite fork portion including a bite fork which may be inserted into the patient's mouth for the purpose of obtaining the patient's bite registration information, and a camera mount portion including a camera oriented toward the patient's face.

### FIELD OF THE INVENTION

The present invention relates to an apparatus and method for use in creating dental prosthetics.

### DESCRIPTION OF THE RELATED ART

The typical process of creating dental prosthetics involves the dental practitioner taking impressions of a patient's upper and lower jaws and then making models of the patient's jaws (for example, out of plaster) which are sent to the dental lab for use in preparing the necessary prostheses. Dental labs utilize dental articulators to mount these dental models and to position the models to approximate the actual positioning of the patient's upper and lower jaws relative to the patient's temporomandibular joint (TMJ). Once mounted, the dental lab is able to use the models as a guide to create and prepare the required prostheses in the proper size and shape prior to actual implantation in the patient's jaws.

In order to accurately mount the dental models to the articulator, it is necessary for the dental practitioner also to obtain bite registration information from the patient to record the proper spatial orientation of the patient's jaws in relation to the TMJ. The patient's bite registration is usually obtained through the use of a device comprising a facebow with an attached bite fork. The facebow portion is usually designed to contact the patient's two ear canals and nose so as to be positioned approximately parallel to the eye-ear plane, and the bite fork can be adjusted to fit the patient's bite. Once the patient's bite registration has been established, the bite fork is fixed in position relative to the facebow, and some or all of the facebow and bite fork device is sent to the dental lab. The device is then mounted to the articulator in order to physically guide the placement of the dental models on the articulator in the proper spatial orientation.

This method has several disadvantages. First, the facebows in common use today require careful manual application by the dental practitioner of the facebow to the patient's face to accurately record the patient's bite registration, and thus these facebows are prone to provide inaccurate bite registration information to the dental lab.

Second, because articulators from different manufacturers vary in size and structure, fewfacebows, if any, are compatible with all articulators. As articulators are generally quite expensive, it is costly for a dental lab to maintain different articulators to be able to use different facebows that may be supplied by dental practitioners.

Third, where most or all of the patient's teeth must be replaced by prostheses, such as in the event of a full mouth restoration, the above-described process does not provide sufficient information or guidance to the dental lab regarding the proper appearance and proportions of the dental prostheses to be prepared in relation to the patient's face, and thus the appearance of the prostheses is almost entirely dependent on the technique and preferences of the individual dental lab technician. As a result, it is difficult without repeated and costly trial-and-error steps to ensure that a finished prosthesis has the correct appearance and proportions when applied to the patient's face.

### SUMMARY OF THE INVENTION

The present invention is directed to an apparatus and a method for use in creating dental prosthetics that addresses the problems discussed above.

In on aspect of the present invention, an apparatus is described that permits the measurement of certain patient information for use with a variety of dental articulators to prepare dental prosthetics, including recording a patient's bite registration, measuring the spatial positioning of a patient's occlusal plane, and recording the patient's facial features in a manner consistent from patient to patient.

In another aspect of the present invention, a method of preparing dental prostheses is described that utilizes certain data regarding the patient's facial features to assist in the preparation of dental prostheses that have the proper proportion, size and appearance in relation to the patient's face.

### BRIEF DESCRIPTION OF THE DRAWINGS

The above and/or other aspects and advantages of the present invention will become apparent and more readily appreciated from the following description of the exemplary embodiments, taken in conjunction with the accompanying drawings of which:

FIG. 1 is a side view of an embodiment of an apparatus for use in creating dental prosthetics.

FIG. 2 is a view from the front end of the apparatus illustrated in FIG. 1.

FIG. 3 is a perspective view of the base portion of the structure 100B illustrated in FIGS. 1 and 2.

FIG. 4-1 is a perspective view of the structure 100C illustrated in FIG. 1.

FIG. 4-2 is a reverse perspective view of the upper portion of structure 100C illustrated in FIG. 4-1.

FIG. 4-3 is a side view of selected elements of the apparatus illustrated in FIG. 1 illustrating certain distances and angles measurable using the apparatus.

FIG. 5 is a diagram of reference lines overlaid on a frontal view of a patient's face used in an embodiment of a method for use in creating dental prosthetics.

FIG. 6 is a diagram of reference lines overlaid on a frontal view of a patient's face used in an embodiment of the method of FIG. 5.

FIG. 7-1 is a diagram of reference lines overlaid on a planar view of a patient's teeth used in an embodiment of the method of FIG. 5.

FIG. 7-2 is a diagram of reference lines overlaid on a frontal view of a patient's teeth used in an embodiment of the method of FIG. 5.

FIG. 8 is a diagram of reference lines overlaid on a frontal view of a patient's face used in an embodiment of the method of FIG. 5.

FIG. 9 is a diagram of reference lines overlaid on a frontal view of a patient's teeth used in an embodiment of the method of FIG. 5.

FIG. 10 is a diagram of reference lines overlaid on an approximately frontal representation of a patient's teeth use in an embodiment of the method of FIG. 5.

### DETAILED DESCRIPTION OF THE EMBODIMENTS

Reference will now be made in detail to exemplary embodiments of the present invention, examples of which are illustrated in the accompanying drawings, wherein like reference numerals refer to like elements throughout. The embodiments are described below in order to explain the present invention by referring to the figures.

According to a first aspect of the present invention, there are provided an apparatus and a method for use in creating dental prosthetics.

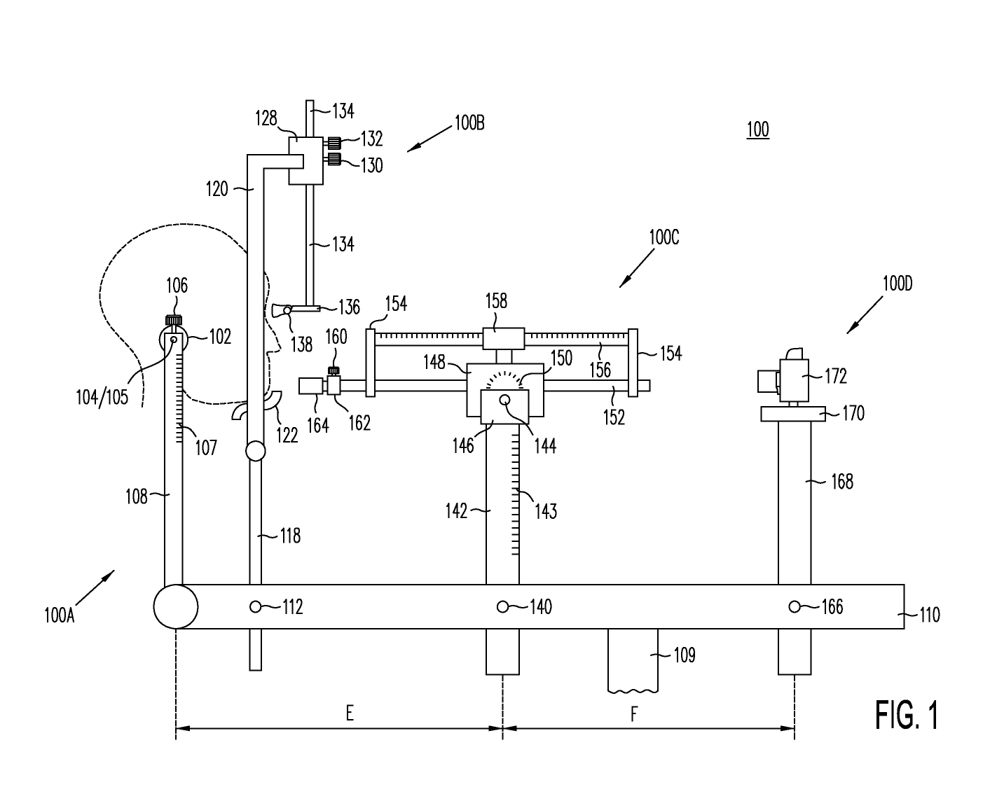

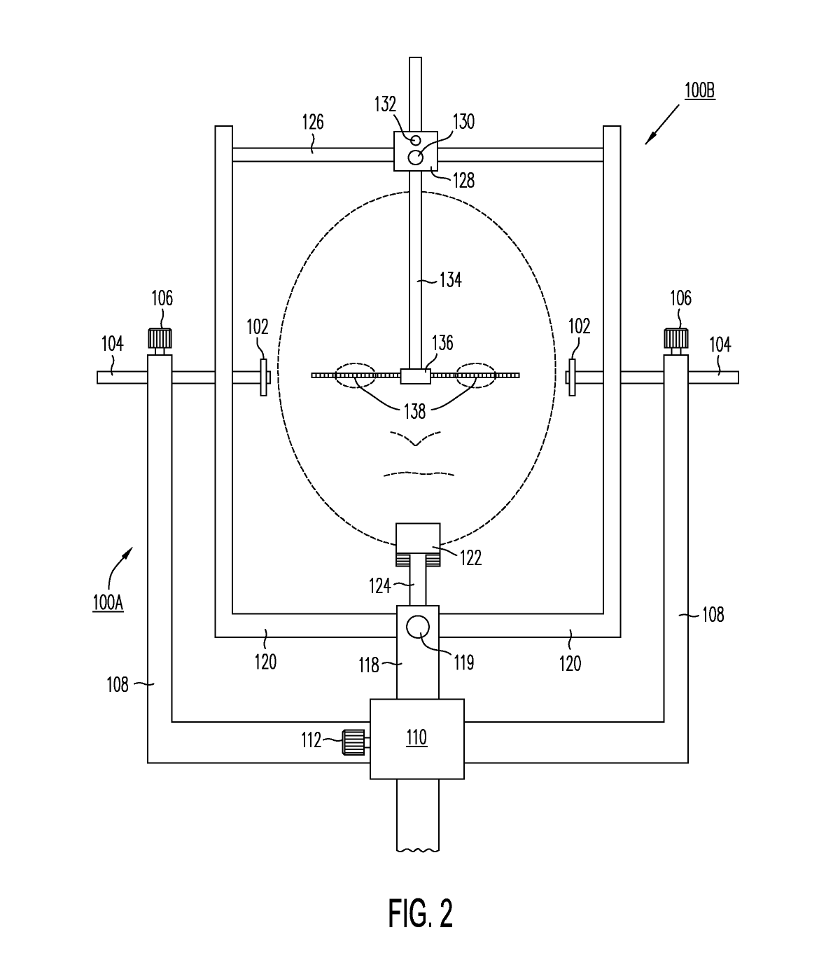

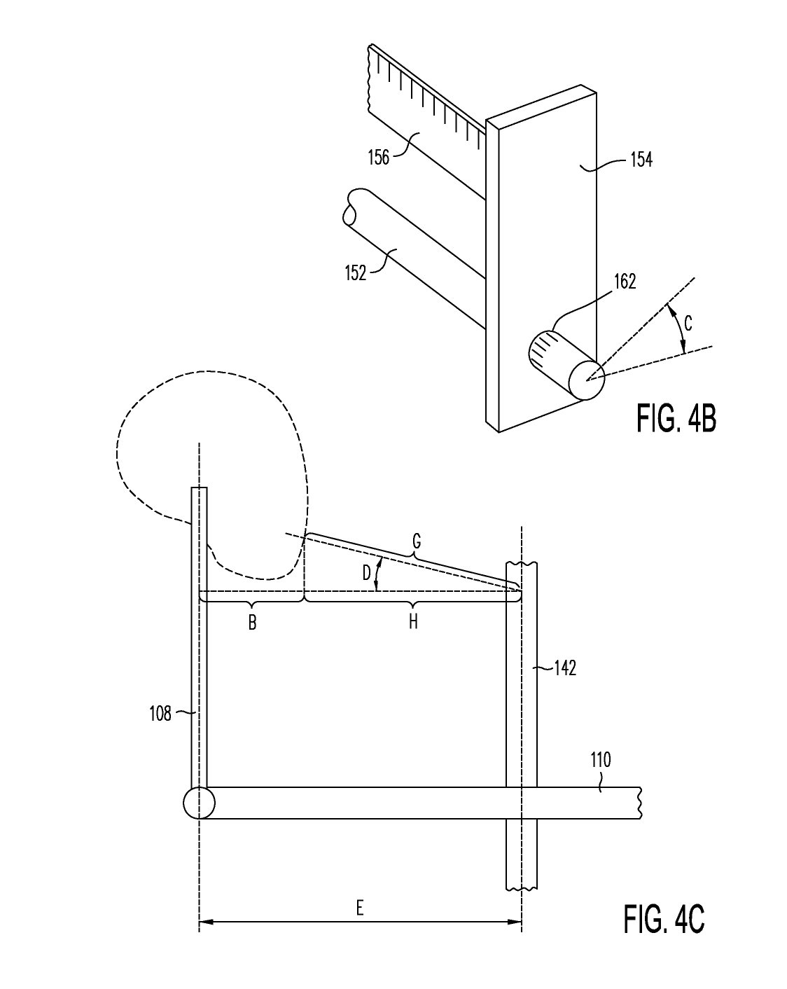

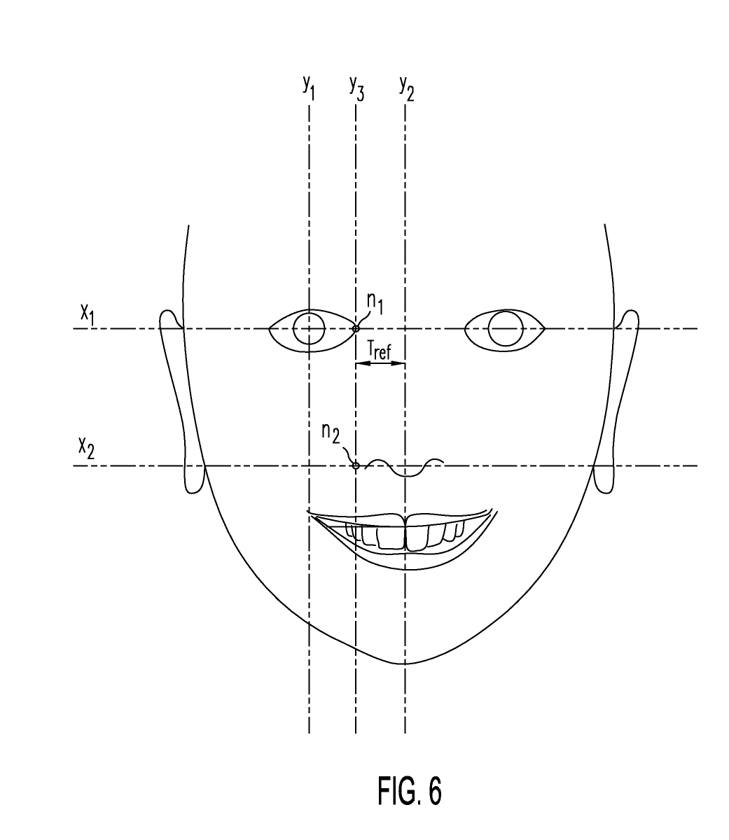

FIGS. 1 through 4-2 illustrate an apparatus 100 according to an embodiment of the invention for obtaining certain data for use in creating dental prosthetics for a particular patient, and FIGS. 5 through 9 illustrate a method for using the apparatus 100 to create a dental prosthesis according to an embodiment of the invention.

With reference to FIGS. 1 through 4-2, the apparatus 100 comprises an ear mount portion 100A, a chin mount portion 100B, a bite fork portion 100C, and a camera mount portion 100D, each attached to a base 110. The ear mount portion 100A and chin mount portion 100B serve to fix the patient's head in position for obtaining consistent measurements of the patient's dental and facial information. The base 110 may be in the form of a bar or other generally straight, narrow and linear form, or a surface that is flat in two dimensions, with sufficient length to permit portions 100A-100D to be linearly mounted in relation to each other as described below. The base 110 is generally oriented horizontally and is fixedly mounted on a base mount 109 such that the base 110 is elevated from any surface on which the base mount 109 is fixed (such as the floor or a tabletop). Hereafter, this orientation of the base 110 is assumed, and the use of terms such as “upper” or “lower” is intended only to describe the relative spatial relationships of the various parts of the apparatus 100. The height or vertical position of the base 110 or the base mount 109 may additionally be adjustable, while maintaining the horizontal orientation of the base 110.

The ear mount portion 100A is generally U-shaped, and comprises two symmetrical and approximately curved or L-shaped ear mount arms 108 joined to form a single plane. The base of the ear mount portion 100A, where the two ear mount arms 108 join, is attached to one end of the base 110 such that the base 110 is orthogonal to the plane formed by the ear mount arms 108, and also such that in the normal orientation of the base 110, the non-attached ends of the ear mount arms 108 are perpendicular to and extend vertically upward. An earpiece rod 104 is inserted through a hole 105 in each non-attached end of each ear mount arm 108 such that the two rods 104 are collinear and parallel to the plane of the base 110. A scale 107 is affixed on each ear mount arm 108 so as to permit measurement of TMJ height A, or the vertical distance from the patient's TMJ to the level of the patient's occlusal plane. An earpiece 102 is attached to the inward-pointing end of each earpiece rod 104. The position of the earpiece rods 104 may be adjusted by loosening screws 106 on each non-attached end of the ear mount arms 108, and may be fixed by re-tightening said screws 106, such that the earpieces 102 may be adjusted to contact a patient's ear canals.

The chin mount portion 100B is positioned on the base 110 between the ear mount portion 100A and the bite fork portion 100C, and is oriented so as to be parallel to the ear mount portion 100A and to extend in the same direction as the ear mount portion 100A from the base 110. The chin mount portion 100B is adjustably attached to the base 110 by means of an approximately rectangular-shaped chin mount post 118 inserted through a generally rectangular chin mount hole 111 in the base 110. The portion of the chin mount post 118 that is approximately within the chin mount hole 111 is preferably rectangular-shaped. The chin mount hole 111 is longitudinally larger in dimension than the chin mount post 118 such that the chin mount post 118 may be moved closer to or farther away from the ear mount portion 100A while inserted through the chin mount hole 111. In one embodiment, the horizontal movement of the chin mount post 118 may be controlled by adjustment gear 117 mounted on one side of the chin mount hole 111 and that makes contact with gear teeth 115. The gear teeth 115 are fixedly attached to the chin mount post 118 such that they extend longitudinally within the chin mount hole 111 and continuously contact the adjustment gear 117. Alternatively, the gear teeth 115 may be cut into a horizontal groove in one longitudinal side of the chin mount post 118 within the chin mount hole 111. The adjustment gear 117 is attached to an adjustment gear knob 112 such that the adjustment gear knob 112 turns the adjustment gear 117 and moves the chin mount post 118 horizontally toward or away from the ear mount portion 100A. Other means of controlling the horizontal movement of the chin mount post 118 such that the chin mount post 118 may be adjusted and then fixed into position may also be employed (e.g., the chin mount post 118 may be vertically fixed in position relative to the chin mount hole 111 by means of a tongue-and-groove assembly, and an adjusting plate may be used that, when loosened, permits the chin mount post 118 to be moved longitudinally, and when tightened, fixes the chin mount post 118 in a particular horizontal position relative to the ear mount portion 100A).

A chin rest post 124 is adjustably inserted into the upper end of chin mount post 118, and may be raised or lowered by loosening and tightening a chin rest tightener 119 (e.g., a screw, gear, or crank). A chin rest 122 is fixedly mounted on top of chin rest post 124. The height of the chin rest 122 and the horizontal position of the chin mount post 118 may be adjusted in order that the patient's chin rest upon the chin rest 122 while the patient's ear canals maintain contact with the earpieces 102. Two approximately curved or L-shaped chin mount arms 120 extend from either side of chin mount post 118, the upper ends of each chin mount arm 120 extending vertically upward such that the plane formed by the chin mount arms 120 is parallel with the plane formed by ear mount arms 108. The upper ends of the chin mount arms 120 protrude away from the plane of the ear mount arms 108 and chin mount arms 120, and are connected by a bar 126 that runs parallel to the two earpiece rods 104. A nosepiece rod 134 is adjustably attached to the bar 126 by means of a nosepiece rod joint 128 and is held in a vertical position by said nosepiece rod joint 128. The nosepiece rod 134 may be raised or lowered by means of loosening and tightening a screw 132, while the nosepiece rod joint 128 may be fixed at different points along bar 126 by means of loosening and tightening a screw 130. Attached to the bottom end of nosepiece rod 128 is a nosepiece 136 for making contact with the bridge of a patient's nose. On either side of nosepiece 136 horizontally extend two eye measurement arms 138, and on each eye measurement arm 138 a measurement scale is provided (e.g., marked or printed) to be read when viewing the patient's face and such that the distance between the patient's pupils may be determined.

The bite fork portion 100C is positioned on the base 110 at a fixed horizontal distance from the ear mount portion 100A (and thus also at a fixed distance from the patient's TMJ) so as to accurately obtain the patient's bite registration once the patient's head is secured by the ear mount portion 100A and the chin mount portion 100B. A bite fork shaft 142 is adjustably inserted through a bite fork hole 141 in base 110 that is at a fixed distance E from the ear mount portion 100A. The bite fork shaft 142 may be raised or lowered through the bite fork hole 141 by means of loosening and tightening a tightener 140 (e.g., a screw, gear, or crank), thereby raising or lowering the bite fork portion 100C. A scale 143 is printed on the bite fork shaft 142 corresponding to the scale 107 on the ear mount arms 108, to permit the bite fork portion 100C to be raised or lowered to a specific height, for example corresponding to TMJ height A. A bite fork cradle 146 is fixed to the upper end of the bite fork shaft 142. A bite fork mount 148 is attached to the bite fork cradle 146 by a bolt 144 so as to permit the bite fork mount 148 to rotate within the bite fork cradle 146 and to be fixed in position once a desired angle for the bite fork mount 148 is achieved. An angular scale 150 is printed on a side(s) of the bite fork mount 148 where said mount 148 is attached to the bite fork cradle 146 by the bolt 144, so as to permit the angle of the bite fork mount 148 to be measured.

A bite fork mounting shaft 152 is adjustably inserted through a hole 147 extending through the two vertical sides of the bite fork mount 148 not directly attached to the bite fork cradle 146 by the bolt 144, so as to permit the bite fork mounting shaft 152 to be extended or retracted through the hole 147. A bite fork 164 is attached to one end of the bite fork mounting shaft 152, and the bite fork portion 100C is positioned such that the bite fork 164 is oriented toward the patient's face when held in place by the ear mount portion 100A and chin mount portion 100B. The bite fork cradle 146 and bite fork mount 148 are mounted on the bite fork shaft 142 such that when the height of the bite fork shaft 142 is fixed to correspond to the TMJ height A, the bite fork mounting shaft 152 is parallel to the base 110 and the bite fork 164 is at the same vertical position as the patient's mouth.

A scale 156 is attached to the bite fork mounting shaft 152 by means of two mounting brackets 154 placed on either side of the bite fork mount 148, such that the scale 156 is parallel to the bite fork mounting shaft 152 and so as to permit the bite fork mounting shaft 152 to rotate within the mounting brackets 154 while maintaining the longitudinal position of the scale 156 relative to the bite fork mounting shaft 152. The scale 156 passes through a measuring device 158 which is fixed to the top of the bite fork mount 148, and is calibrated so as to measure the distance G along the bite fork mounting shaft 152 from the bite fork 164 to the center of the bite fork shaft 142. A mold or impression of the patient's teeth may also be obtained using the bite fork 164 in a manner similar to other commonly-used bite forks.

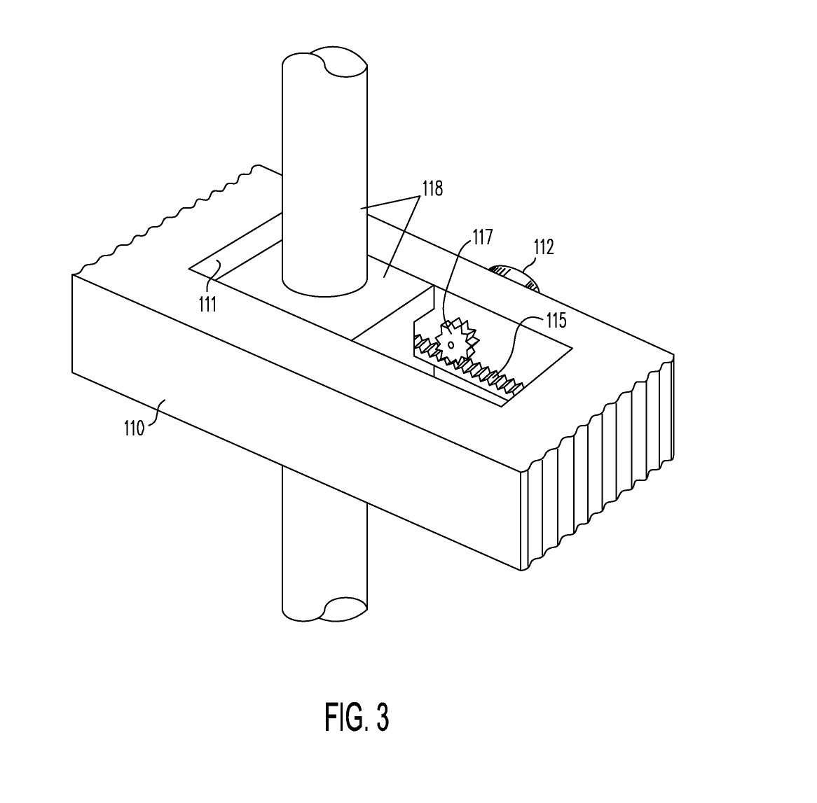

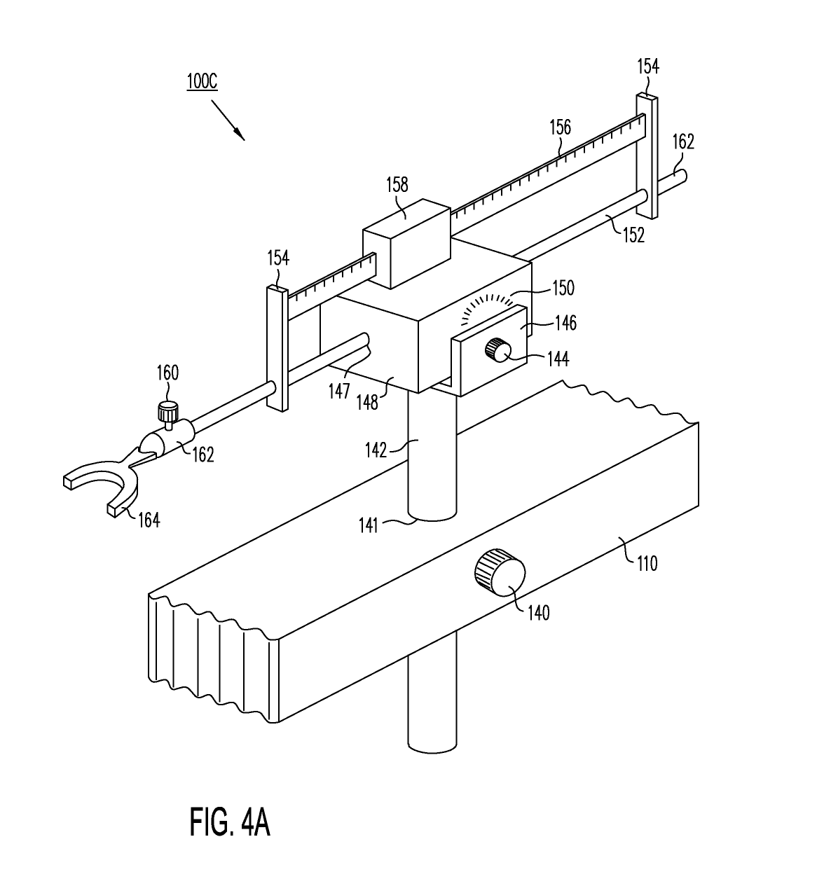

The bite fork 164 may be adjustably rotated along with the bite fork mounting shaft 152 to measure the left-to-right occlusal angle C of the occlusal plane of the patient's jaws around the axis formed by the bite fork mounting shaft 152. A scale 162 may be provided (e.g., printed) on or around the bite fork mounting shaft 152 in order to measure said left-to-right occlusal angle C. The bite fork section 100C may also be used to measure the front-to-back occlusal angle D of the patient's occlusal plane by raising or lowering the bite fork shaft 142 through the bite fork hole 144 and simultaneously tilting the bite fork mount 148 while the bite fork 164 is engaged in the patient's mouth until the bite fork 164 is positioned so as to match the front-to-back angle of the patient's occlusal plane. The front-to-back occlusal angle D may then be determined by using the scale 150 printed on the side of the bite fork mount 148. As illustrated in FIG. 4-3, when the bite fork 164 is inserted into the patient's mouth to obtain the patient's bite registration, the distance G and the front-to-back occlusal angle D may be used to determine the horizontal distance H from the patient's anterior teeth to the bite fork shaft 142, and the TMJ-to-anterior distance B from the patient's TMJ to the patient's anterior teeth may thus be calculated by subtracting the distance H from the fixed distance E.

The camera mount portion 100D positioned on the base 110 at a fixed horizontal distance away from the ear mount portion 100A that is further from said ear mount portion 100A than the bite fork portion 100C. A camera mount shaft 168 is adjustably inserted through a camera mount hole 165 in base 110 that is at a fixed distance F from the ear mount portion 100A. The camera mount shaft 168 may be raised or lowered through the camera mount hole 165 by means of loosening and tightening a tightener 166 (e.g., a screw, gear, or crank), thereby raising or lowering the camera mount portion 100D. A camera mount 170 is fixed to the upper end of the camera mount shaft 168, where a camera 172 may be attached such that an image may be taken of the patient's face while set in the ear mount portion 100A and chin mount portion 100B. To ensure the consistency of images from patient to patient, the camera mount shaft 168 is raised or lowered such that the tip of the patient's nose is centered in the viewfinder of camera 172.

With reference to FIGS. 1 through 10 according to an embodiment of the invention, the following method may be used to obtain measurements and information from a patient for the purpose of preparing dental prosthetics of the correct visual appearance and proportions. A patient's head is positioned on the apparatus 100 such that the ear pieces 102 may be adjusted to fit into the patient's ear canals, and the patient's chin may simultaneously rest on the chin rest 122 after adjusting the chin mount post 118 and the chin rest post 124. The patient's head thus should be approximately horizontally centered between the ear mount arms 108 and the chin mount arms 120 when viewed from the front. The nosepiece rod joint 128 and the nosepiece rod 134 are then adjusted such that the nosepiece 136 makes contact with the patient's upper nose and is centered between the patient's eyes. Once all four contact points between the apparatus 100 and the patient's head are established (each ear canal, chin, and nose), the patient's head is properly positioned to obtain the required measurements for preparing a dental prosthesis.

The patient's bite registration is then taken. The height of the bite fork portion 100C is adjusted to match the TMJ height A as measured on the ear mount arms 108, such that the bite fork 164 is at the same vertical height as the patient's mouth. The bite fork mounting shaft 152 is extended toward the patient's mouth such that the patient is able to bite down on the bite fork 164. The bite fork mounting shaft 152 is twisted as necessary to match the left-to-right angle of the patient's occlusal plane, and the angle of the bite fork mount 148 and the height of the bite fork shaft 142 are adjusted as necessary to match the front-to-back angle of the patient's occlusal place. Once the bite fork 164 is correctly positioned in the patient's mouth, the TMJ-to-anterior distance B is obtained using the scale 156, the left-to-right occlusal angle C is obtained using the angular scale 150, and the front-to-back occlusal angle D is obtained using the scale 162.

Once these measurements are taken, the bite fork portion 100C may be removed from the base 110. The bite fork portion 100C is then positioned relative to a dental articulator such that the bite fork 164 is correctly positioned within the dental articulator to permit the patient's dental models to be mounted to the articulator in the proper spatial orientation. Alternatively, the measurements are recorded and transmitted to a dental lab for use in positioning a second bite fork portion 100C relative to an articulator. As dental articulators are generally designed to replicate the position of a patient's jaws relative to the TMJ, and as the TMJ height A and the TMJ-to-anterior distance B of the patient have been obtained as described above, it is thereby possible for one skilled in the art to establish the proper relative positions of the articulator and the bite fork 164, such as by fixing the bite fork portion 100C in place and adjusting the position of the articulator relative to the bite fork portion 100C consistent with the patient's measurements, or vice versa.

The bite fork portion 100C is also removed from the base 110 in order to permit an image to be taken of the patient's face while still set within the apparatus 100. The camera mount shaft 168 is adjusted such that the viewfinder of the camera 172 mounted to the camera mount 170 is centered on the patient's nose tip. Once the camera 172 is in the correct position, the patient is directed to smile so as to expose the patient's upper teeth, and the image is taken. The correct shape of the patient's dental prosthetics may be determined with reference to the image as follows.

The following steps of the claimed method, as shown in FIGS. 5 through 10, will be described with reference to one side of the image of the patient's face only, corresponding to the anterior teeth (i.e., teeth numbers 6 through 11 and 22 through 27) on the same side of the patient's face. However, the patient's face is assumed to be approximately symmetrical, and thus the claimed method may be applied in reverse on the other side of the patient's face to correspond to the anterior teeth on that side also. As shown in FIG. 5, an upper ear line x₁ is horizontally traced on the image through the two points e where the patient's upper ears join with the patient's head. A lower ear line x₂ is horizontally traced on the image through the two points f where the patient's lower ears join with the patient's head. An eye-mouth line y₁ is vertically traced through the patient's pupil and the corner of the patient's mouth, such that the eye-mouth line y₁ intersects with the upper ear line x₁ at point g, and with the lower ear line x₂ at point h. A face center line y₂ is vertically traced through the image so as to bisect the patient's face.

Once the above points and lines are drawn, the following reference lines may be determined. A face outline l₁ is drawn through point e and point f so as to form a line approximately tangential to the patient's face. A face line l₂ is drawn through a point i, located on the upper ear line x₁ midway between point e and point g, and a point j, located on the lower ear line x₂ midway between point f and point h. An upper lip line l₃ is drawn along the curve formed by the two corners of the patient's mouth and the lower edge of the center of the patient's upper lip (while smiling) so as to form a curved line extending to either side of the patient's face. The upper lip line l₃ corresponds to the patient's incisal line. A chin angle line l₄ is drawn along the curve formed by the contour of the patient's depressor anguli oris or triangularis muscle and the patient's chin.

Using the above reference lines, the proper shape of the patient's upper anterior teeth may be determined as follows. A tooth outline m₁ is determined by tracing a curved line beginning at the upper lip line l₃ at the center of the patient's upper lip, extending vertically through the lower part of the patient's nose, curving outward to correspond to the patient's eyebrow, curving downward and outward so as to meet and overlap the face outline l₁, and continuing downward to contact the upper lip line l₃ once again. The disto-labial angle of the tooth outline m₁ (i.e., the lower outer corner of the tooth outline m₁, or the lower corner farthest from the patient's nose) is then adjusted to correspond to the curvature of the chin angle line l₄. The resulting outline formed by the tooth outline m₁, upper lip line l₃, and adjusted lower corners approximately corresponds to the proper outline of the patient's upper anterior teeth when frontally viewed.

A tooth contour line m₂ is determined by tracing a curved line beginning at a point on the upper lip line l₃ that is slightly laterally offset from the center of the patient's teeth, extending vertically through the lower part of the patient's nose, curving outward to correspond to the upper edge of the patient's eye, curving downward and outward to contact the face line l₂, and then curving downward to contact the upper line line l₃ on a curve approximately corresponding to the patient's depressor anguli oris or triangularis muscle. The resulting tooth contour line m₂ approximately corresponds to the contour on the facial surface of the patient's upper anterior tooth where the facial surface transitions into the proximal and gingival surfaces of the tooth.

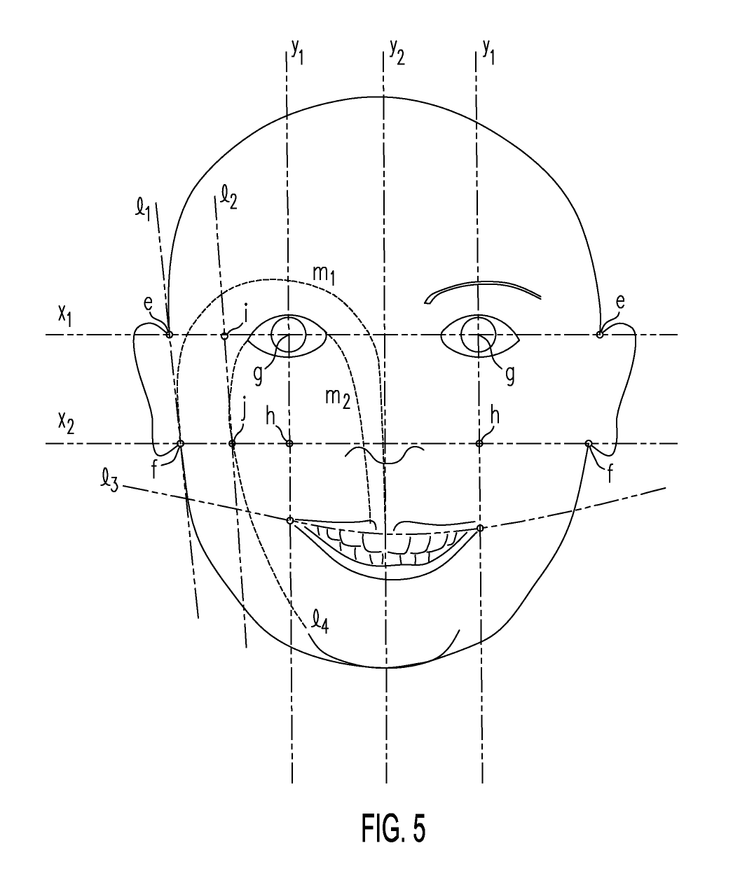

The proper size of the patient's visible upper teeth (i.e., tooth numbers 4 through 13) may be determined as follows. With reference to FIG. 6, a point n₁ is located on upper ear line x₁ halfway between eye-mouth line y₁ and face center line y₂. A point n₂ is similarly located on lower ear line x₂ halfway between eye-mouth line y₁ and face center line y₂, on the same side of the patient's face as point n₁. A canine line y₃ is vertically traced through point n₁ and point n₂, and should approximately intersect with the cusp of the patient's canine or cuspid tooth (i.e., tooth number 6 or 11). Thus, the distance T_{ref} between point n₁ and face center line y₂ should correspond to the horizontal distance from the center of the patient's upper teeth (i.e., between tooth numbers 8 and 9) and the cusp of the patient's canine tooth.

A width T₁ of each of the patient's central upper incisors (i.e., tooth numbers 8 and 9) may be determined as follows. Due to the curvature of the maxillary arch, each subsequent lateral tooth from the central incisors has an apparent frontal width (i.e., width when viewed from the front) of three-quarters the apparent frontal width of the immediately mesial tooth. For example, each lateral incisor (i.e., teeth number 7 and 10) has an apparent frontal width T₂ equivalent to 0.75*T₁. Each canine tooth (i.e., teeth number 6 and 11) has an apparent frontal width T₃ equivalent to 0.75*(0.75*T₁), and so on for each subsequent lateral tooth. The distance T_{ref} being known, the width T₁ thus may be calculated according to the equation T₁=T_{ref}−T₂−_T₃.

The placement and width of each remaining visible upper tooth may be determined by reference to the apparent frontal width of each visible upper tooth and each tooth's placement on the patient's maxillary arch, as shown in FIGS. 7-1 and 7-2. The proper height of each tooth is approximately 1.24 times the width of the tooth.

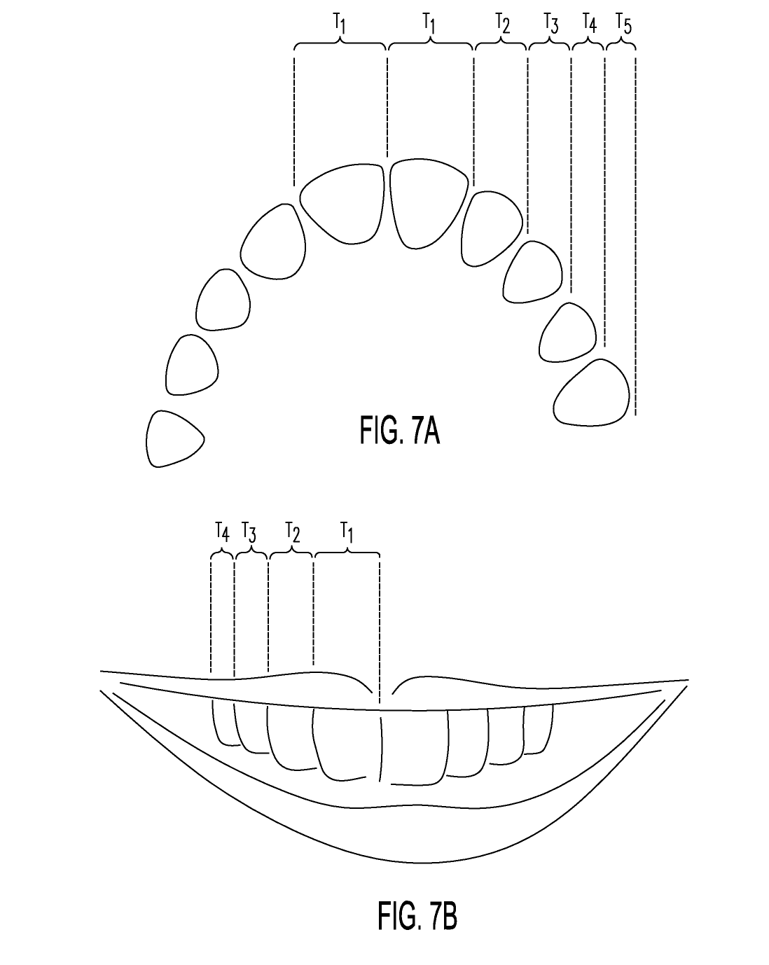

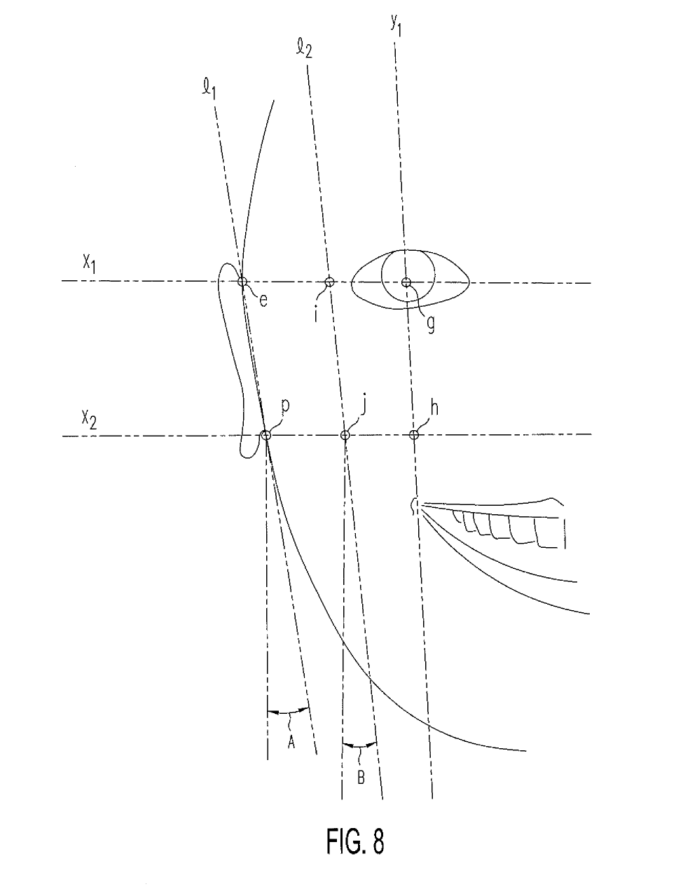

The angle of each visible upper tooth when frontally viewed may be determined as follows. With reference to FIGS. 5, 8 and 9, as explained above, the outer edge of the tooth outline m₁ largely overlaps the face outline l₁. The face outline l₁ generally has an angle A from the vertical, as shown in FIG. 8. Thus, the outer edge of the patient's central upper incisors should be angled at approximately the same angle A as the face outline l₁. The angle of each subsequently lateral tooth should be 3 degrees greater than the immediately mesial tooth, as shown in FIG. 9. That is, the angle of the lateral incisor should be angle A plus 3 degrees, the angle of the canine or cuspid tooth should be angle A plus 6 degrees, and so on.

The angle of the tooth contour as represented by the tooth contour line m₂ is similarly calculated. The face line l₂, corresponding to the outer edge of the tooth contour as represented by tooth contour line m₂, generally has an angle B from the vertical, as shown in FIG. 8. The outer edge of the tooth contour of the patient's central upper incisors should be angled at approximately the same angle B as the face line l₂. The angle of the tooth contour of each subsequently lateral tooth should be 3 degrees greater than the immediately mesial tooth, in a manner similar to that described in FIG. 9 with respect to angle A.

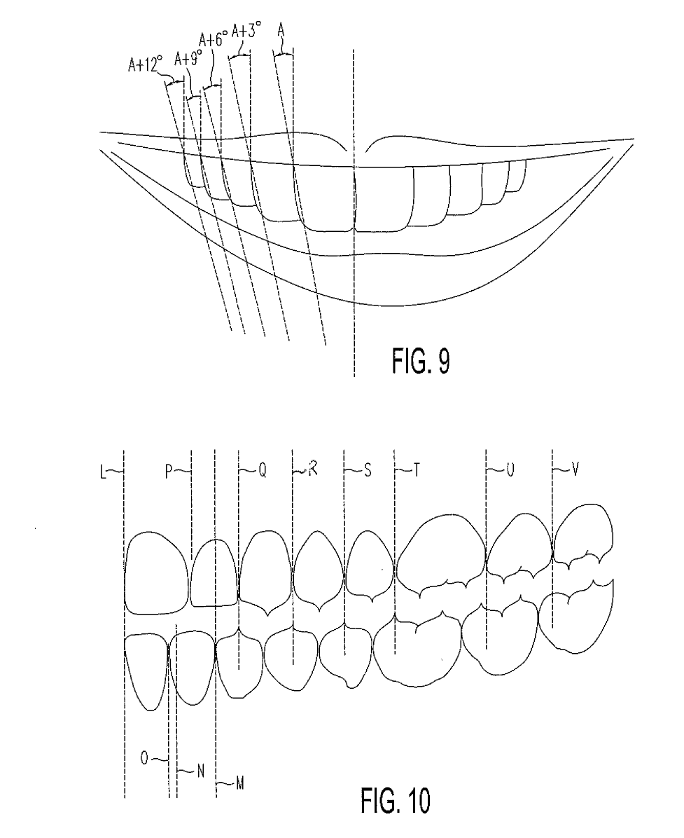

With reference to FIG. 10, the proper proportions of the patient's lower teeth may be determined by reference to the patient's upper teeth. Line L corresponds to the center line between the patient's central incisors. Line M corresponds to the outer edge of the lower lateral incisor (i.e., tooth number 23 or 26 depending on which side of the patient's face is being viewed). The placement of line M also corresponds to the center of the patient's lateral upper incisor (i.e., tooth number 7 or 10). Line N is located halfway between lines L and M, and approximately corresponds to the gap between the patient's lower central and lateral incisors. However, the lower central incisor is generally approximately 1 mm narrower than the lower lateral incisor, and so the outer edge of the lower central incisor and the inner edge of the lower lateral incisor meet at a line O located ½ mm from line N in a mesial direction. A line P corresponding to the gap between the patient's central and lateral upper incisors should approximately intersect with the center of the patient's lower lateral incisor. Lines Q through V, corresponding to the remaining gaps between the patient's upper teeth, should each approximately correspond to the cusp tip of the lower tooth located below each such gap. In this way, the size and placement of each of the patient's lower teeth may be determined.

Although a few embodiments of the present invention have been shown and described, it will be appreciated by those skilled in the art that changes may be made in these embodiments without departing from the principles and spirit of the invention, the scope of which is defined in the appended claims and their equivalents.

1. An apparatus for use in creating dental prosthetics, comprising:
a base;
an ear mount portion for making contact with a patient's head such that temporomandibular joints within the patient's head are maintained in a level fixed position equidistant from the base;
a chin mount portion for making contact with the patient's chin and the patient's nose bridge, such that the patient's chin and nose bridge are maintained in an orientation that is perpendicular relative to the base;
a bite fork portion comprising a bite fork which may be inserted into the patient's mouth for the purpose of obtaining bite registration information of the patient; and
a camera mount portion comprising a camera oriented toward the patient's face.

2. The apparatus of claim 1, wherein the ear mount portion, the bite fork portion, and the camera mount portion are positioned at fixed horizontal distances from each other on the base.

3. The apparatus of claim 2, wherein the bite registration information comprises at least a front-to-back occlusal angle of an occlusal plane of the patient, a left-to-right occlusal angle of the occlusal plane, and a horizontal distance from the patient's temporomandibular joint to the patient's anterior teeth, and an angular position, rotational position, and vertical position of the bite fork is adjustable such that the bite fork may be positioned so as to approximately correspond to the occlusal plane of the patient.

4. The apparatus of claim 3, where the bite fork portion is removable from the base and may be positioned relative to a dental articulator so as to correspond to the patient's bite registration information.

5. The apparatus of claim 4, further comprising a scale for measuring a distance between the patient's pupils.
